(19) United States
(12) Patent Application Publication
(10) Pub. No.: US 2001/0033073 A1
(43) Pub. Date: Oct. 25, 2001

(54) Safety system including deployable panel for occupant protection in a vehicle rollover

(76) Inventors: Kimberly Jean Hammond, Clinton Township, MI (US); Brian Hale Staser, Troy, MI (US); Chantal S. Parenteau, Troy, MI (US)

Correspondence Address: KATHRYN A. MARRA, DELPHI TECHNOLOGIES, INC., Legal Staff, Mail Code: 480-414-420, P.O. Box 5052, Troy, MI, 48007-5052, US

(21) Appl. No.: 09/789,315

(22) Filed: Feb. 20, 2001

Related U.S. Application Data
(60) Provisional application No. 60/192,022, filed on Mar. 24, 2000.

(51) Int. Cl. B60R 21/16

(52) U.S. Cl. 280/730.2

(57) ABSTRACT

A safety system including a substantially membrane-like panel which is deployable at least partially across a window opening of a transportation vehicle in a rapid manner from a position generally below the window opening. The panel provides a restraining barrier against undesired egress through the window opening during an extended rollover collision event. The panel may be used either alone or in combination with an inflatable air bag cushion.

### TECHNICAL FIELD

This invention relates to an occupant protection system for a transportation vehicle such as an automobile which includes a deployable panel of material for deployment over a window opening from a position below the window opening such that the panel provides a barrier extending across at least a portion of the window opening to provide cushioning restraint against egress through the window opening during a roll-over collision event.

### BACKGROUND OF THE INVENTION

It is well known in motor vehicles to provide inflatable air bag systems for the protection of a vehicle occupant. Such systems typically include an impact sensing device in communication with a gas generator which releases an inflating medium to fill a gas retaining cushion during the impact event. It is also known to provide substantially curtain-like inflatable cushion structures which are deployable downwardly away from the roof line of the vehicle in covering relation to a side portion of the vehicle adjacent to an occupant to be protected. Such curtain-like air bag structures are intended to provide the dual roll of cushioning the impact by the occupant to be protected while at the same time providing a resilient barrier across at least a portion of the window opening adjacent to the occupant so as to affirmatively restrain the occupant within the protective enclosure of the vehicle frame. One such inflatable curtain-like structure is illustrated and described in U.S. Pat. No. 6,168,191 to Webber et al. issued Jan. 2, 2001, the contents of which are incorporated herein by reference.

Inflatable curtain-like structures have proven useful in providing cushioning restraint to the vehicle occupants but are typically limited to a single use and rely upon a relatively complex system of inflation and deployment to achieve the desired coverage in a tensioned orientation across the window openings. A substantial degree of the complexity in such inflatable curtain structures arises from the need for such structures to form a stable barrier across the surface to be covered thereby requiring that the entire cushion be held in tension upon deployment. It has been found that meeting these requirements may lead to substantial complexity in the manufacture of such cushions.

### SUMMARY OF THE INVENTION

This invention provides advantages and alternatives over the prior art by providing a safety system including a substantially membrane-like panel which is deployable at least partially across a window opening of a transportation vehicle in a rapid manner from a position below the window opening so as to provide a restraining barrier against undesired egress through the window opening during an extended collision event. The operation of the deployable panel is not dependent upon the ability to control and maintain inflation during such a collision event.

According to one embodiment, the system of the present invention may further include an inflatable air bag cushion deployable inboard of the panel to provide additional cushioning to the occupant to be protected. In such an arrangement, the deployed panel provides a stabilizing support structure for the deployed cushion. The provision of such support may reduce or eliminate the need for the cushion to be held in a taut orientation across the window openings thereby reducing the complexity of the cushion structure.

According to a further embodiment, the deployable panel may be deployed on demand by a vehicle occupant as well as automatically upon receipt of a deployment signal during an appropriate collision event. The panel of the present invention may thus be used as a sun shade during normal operation of the vehicle which may provide safety benefits by reducing the potential for the occurrence of a collision event which might otherwise take place if the vision of the vehicle operator is impeded by the glare of the sun.

These and other advantages are accomplished in a potentially preferred form of the invention by providing a safety system including a substantially pliable panel of material which is deployable in covering relation across at least a portion of a window opening from a position generally below the window opening such that upon deployment, the panel forms a membrane-like barrier to premature egress of a vehicle occupant through the window opening. The panel of material is preferably raised away from its nonactivated storage position below the window opening by an arrangement of hoist lines attached at the upper edge of the panel and traveling in hidden relation over pulley guides to an activatable take-up mechanism for lengthening or shortening the effective length of the hoist lines. The effective length of the hoist lines is increased or decreased by driving the take-up mechanism in the appropriate direction such that upon shortening the effective lengths of the hoist lines the panel is pulled out of its storage position in a substantially taut orientation across the window opening and is held in place at such position until the effective length of the hoist lines is thereafter increased by reversing the hoist line take-up mechanism. The panel is preferably stored in wrapped relation around a storage roll which is driven in conjunction with the hoist line take-up mechanism such that upon a shortening of the hoist lines, the panel is simultaneously fed away from the storage roll and such that upon a lengthening of the hoist lines the panel is wound back into position around the storage roll. Both the activation of the take-up mechanism and the rotation of the storage roll may be carried out by a single reversible drive motor suitable for receipt of both manual and automated activation signals.

In accordance with another potentially preferred aspect of the present invention, the panel is of a substantially mesh-like net material including a multiplicity of interstitial openings across the surface such that the panel provides shade against the sun while nonetheless being substantially see-through so as not to substantially impede the vision of the vehicle operator or other occupants within the vehicle interior.

In accordance with still another aspect of the present invention, the panel may be deployed across a plane extending inboard of an adjustable window within the window opening so as to provide a barrier against the introduction of broken glass into the interior of the vehicle during a collision event.

In accordance with still another aspect of the present invention, the deployable panel may be deployed outboard of an inflatable curtain-like cushion structure such that the inflatable cushion structure extends in a plane between the panel and the occupant to be protected. In such an arrangement the panel serves as a resilient backing support for the curtain-like cushion.

Advantageously, the safety system of the present invention employing the deployable panel provides a potentially beneficial restraint barrier of non-fracturing character across an opening within the vehicle through which undesired egress may otherwise take place during an extended roll-over event. The deployed panel is useful either independently or in conjunction with an additional inflatable cushion. Moreover, the panel may be easily activated and thereafter reset by a reversible motor thereby permitting the panel to function in both active and passive deployment modes. The ability to actively deploy and retract the panel further permits the panel to be used as a sun shade thereby potentially further enhancing the operational safety of the vehicle.

### BRIEF DESCRIPTION OF THE DRAWINGS

The accompanying drawings which are incorporated in and which constitute a part of this specification illustrate a potentially preferred embodiment of the present invention and, together with the general description of the invention given above and the detailed description set forth below, serve to explain the principles of the invention wherein:

FIG. 1 is a cut-away view of the interior of an automotive vehicle incorporating the present invention prior to deployment;

FIG. 2 is a view similar to FIG. 1 following activation of the safety system;

FIG. 3 is an enlarged view of a safety system according to the present invention in a deployed state;

FIG. 4 is a view taken generally along line 4-4 in FIG. 3;

FIG. 5 is a view similar to FIG. 1 illustrating a second embodiment of a system according to the present invention which includes a deployable curtain-like inflatable air bag cushion prior to activation;

FIG. 6 is an enlarged view of the area of deployment in FIG. 5 following activation of the system; and

FIG. 7 is a view similar to FIG. 4 illustrating a deployed arrangement of elements in the system illustrated in FIGS. 5 and 6.

While the invention has been illustrated and generally described above and will hereinafter be described in connection with certain preferred embodiments and practices, it is to be understood that in no event is the invention to be limited to such illustrated embodiments and practices. On the contrary, it is intended that the present invention shall extend to all alternatives and modifications as may embrace the principles of this invention within the true spirit and scope thereof.

### DESCRIPTION OF THE PREFERRED EMBODIMENT

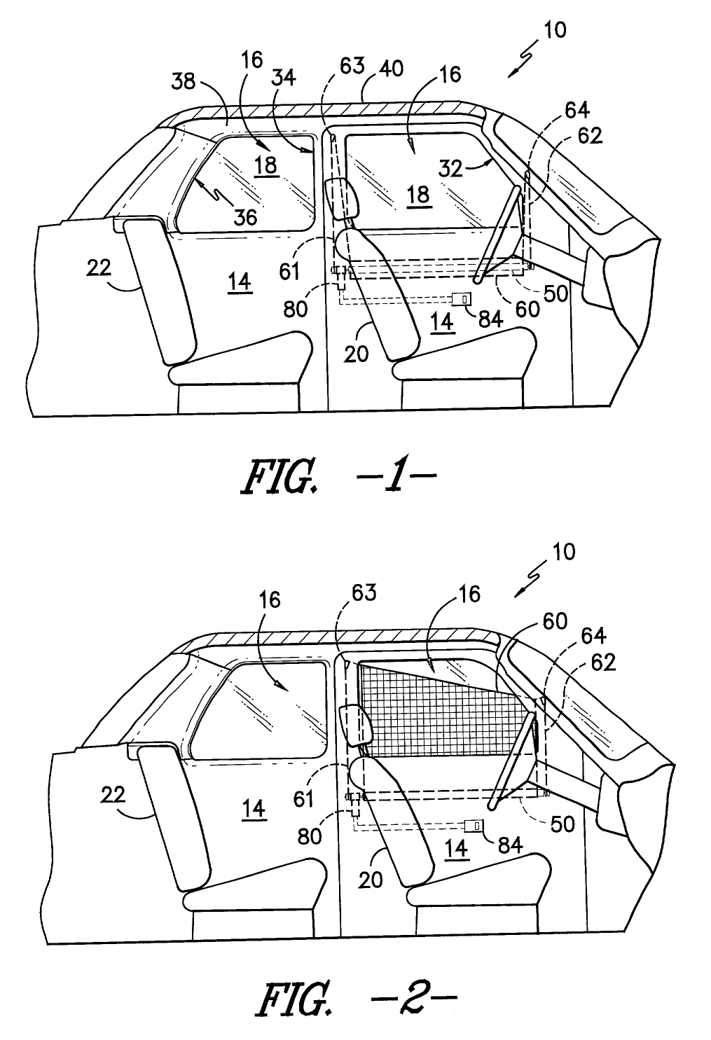

Referring to FIG. 1, it is seen that a vehicle 10 includes one or more doors 14 or other side panel elements having window openings 16 including see-through windows 18 of glass or the like. The vehicle 10 includes a front seat 20 which may be used to support a front seated vehicle occupant. The vehicle 10 may further include a rear seat 22 which may be used to support a rear occupant. While the front seat 20 and the rear seat 22 are illustrated as being located on the operator's side of the vehicle 10, it is to be appreciated that the present invention is also useful in the protection of an occupant seated in either the front seat or a rear seat on the passenger side of the vehicle 10.

As illustrated, the window openings 16 are located generally adjacent to the seats 20, 22 to the sides of the occupants seated therein. The window openings 16 are preferably bounded along their upper and lateral edges by portions of the vehicle structural support frame which includes a series of structural pillars 32, 34, 36 which extend downwardly from the structural roof rail 38 at the intersection between the roof 40 and the top of the window openings 16. As will be appreciated, each of the structural support pillars 32, 34, 36 is preferably covered by a trim piece of plastic or the like as will be well known to those of skill in the art. The roof rail 38 is likewise covered by headlining or trim material in a manner as will be well known to those of skill in the art.

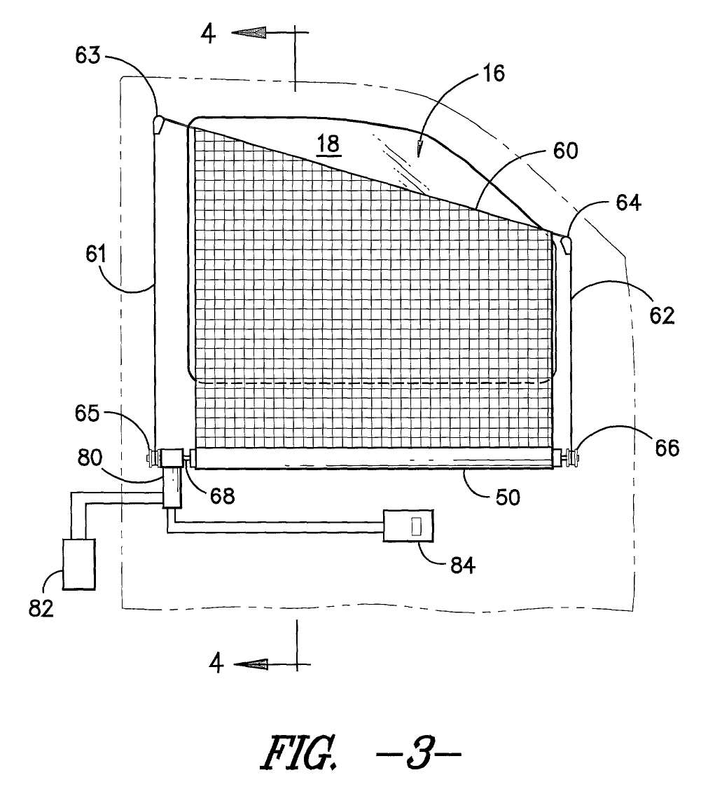

According to the illustrated embodiment, a storage roll 50 is housed at a position generally below at least one of the window openings 16 within at least one of the doors 14. The storage roll 50 supports a panel 60 of substantially pliable material wound around the storage roll 50 such that unwrapping of the panel 60 from around the storage roll 50 permits the panel 60 to be raised into an operative position across at least a portion of the window opening 16 (FIG. 2). As will be appreciated, while the storage roll 50 and deployable panel 60 are illustrated as being arranged to provide deployment over a single side window opening 16 adjacent to the front seat 20, it is contemplated that a similar arrangement may be mounted in the door 14 adjacent to the rear seat 22 if desired. It is also contemplated that a storage roll 50 and deployable panel 60 may be mounted below window openings 16 in structures other than dynamic doors such as the side wall structures of buses or trains. Thus, the present invention is in no way limited to application within door structures of automobiles.

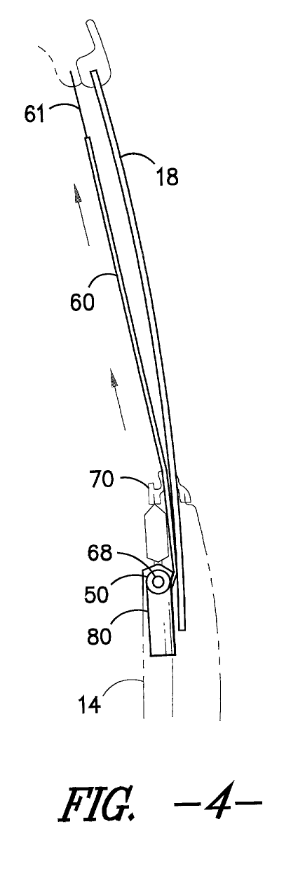

As illustrated in FIGS. 2 and 3, the panel 60 is preferably of a substantially net-like configuration having a surface defined by a multiplicity of interstitial openings through which light may be filtered while nonetheless permitting visibility to be maintained. Thus, upon raising the panel 60 into an operative position across a window opening 16 an occupant seated adjacent to the region covered by the panel may nonetheless see through the panel. At the same time, the light filtration provided by the grid configuration of the panel 60 mitigates the impact of glare from direct sunlight thereby reducing the possibility that such glare will interfere with the ability of the occupant to distinguish objects outside of the vehicle 10.

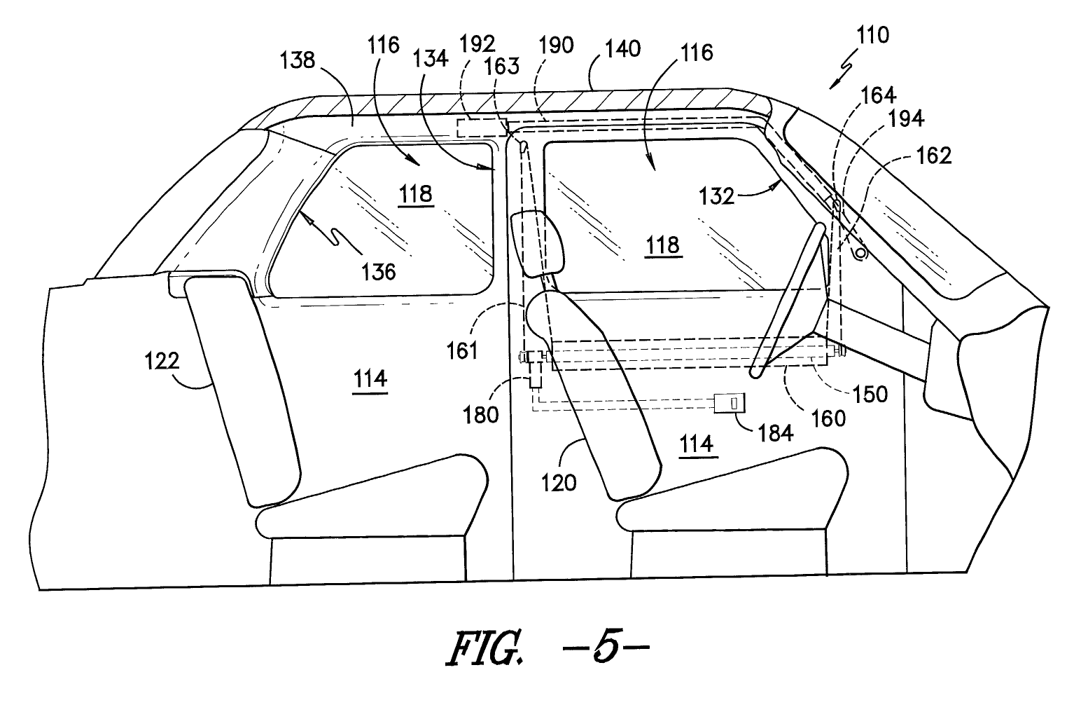

As best illustrated in FIG. 4, it is contemplated that the panel 60 will preferably be deployed across the inboard surface of the window 18 so as to establish a barrier between the occupant to be protected and the window 18. By utilization of such a deployed arrangement, the panel 60 may provide the occupant with a degree of protection against impingement of broken glass or other material forming the window 18. As will be appreciated, such breakage may take place in the event of a side impact or extended roll-over collision event.

According to a potentially preferred arrangement, the panel is pulled upwardly away from the storage roll 50 and through a gap between the window 18 and interior weather stripping 70 as shown. The substantially pliable, membrane-like structure of the panel 60 is believed to facilitate the achievement of such an arrangement.

As best illustrated through reference to FIG. 3, the panel 60 is preferably raised into an operative position by an arrangement of hidden hoist lines 61, 62 which extend away from upper comer portions of the panel 60 and over pulley guides 63, 64 beneath the trim elements on either side of the window opening 16 as shown. As shown, in the raised position the panel 60 preferably extends in spanning relation substantially across the width of the window opening 16 to form a protective barrier against premature egress.

According to the illustrated embodiment of the present invention, the hoist lines 61, 62 are operatively connected to take-up rolls 65, 66 which are preferably mounted adjacent each end of the storage roll 50. The operative length of the hoist lines 61, 62 may be increased or decreased by rotation of the take-up rolls 65, 66. As the operative length of the hoist lines 61, 62 is decreased, the panel 60 is caused to be pulled upwardly towards the pulley guides 63, 64. As will be appreciated, the take-up rolls 65, 66 may be of differing diameters such that an equal number of rotations causes a differing length of the hoist lines 61, 62 to be taken up. Thus, by the selection of the appropriate ratio between the diameters of the take-up rolls 65, 66, a controlled and complete deployment of the panel 60 may be achieved despite differing lengths in the hoist lines 61, 62.

The storage roll 50 as well as the take-up rolls 65, 66 are preferably carried on a common driven spindle 68 which is operatively connected to a reversible motor 80 such that the spindle can be rotated in both directions. By way of example only, and not limitation, a motor capable of driving the spindle 68 and attached take-up rolls 65, 66 at a rate of about 6000 revolutions per minute or greater may be desirable. It is contemplated that during operation using such a motor that deployment of the panel 60 over a typically sized 500 mm window opening may be carried out in less than about 0.2 seconds.

The use of a commonly driven spindle 68 requires that the panel 60 be unwound from the storage roll 50 while rotation is taking place to cause the collection of the hoist lines 61, 62 about the take-up rolls 65, 66. This characteristic is achieved by extending the panel 60 away from the storage roll 50 on an opposing side of the roll from the plane of engagement established between the hoist lines 61, 62 and the take-up rolls 65, 66. Thus, if a clockwise rotation of the spindle 68 causes the hoist lines 61, 62 to be shortened, the same clockwise rotation of the storage roll 50 causes the panel 60 to be unwound thereby permitting it to be raised away from the storage roll 50. By selection of the diameter of the storage roll 50 relative to the take-up rolls 65, 66, tension may be maintained across the panel 60 substantially throughout the deployment process.

According to a potentially preferred embodiment of the present invention, the motor 80 is linked in communication with a sensor 82 measuring side impact and/or vehicle roll-over conditions. Upon measuring predetermined vehicle conditions such as side impact or axial tilt exceeding predetermined values, the sensor 82 transmits a signal to the motor 80 instructing the motor to rapidly rotate the spindle 68 in the direction to shorten the hoist lines 61, 62 and to thereby raise the panel 60 across the window opening 16. The motor 80 is also preferably linked to a manually activatable switch element 84 which permits an occupant in the vehicle 10 to raise or lower the panel to a degree as may be desired during normal operation. The switch element 84 will thereby operate in a manner similar to well known switching elements utilized to raise and lower the windows 18.

In the event that the motor 80 is activatable by both the sensor 82 as well as by the switch element 84, the motor 80 is preferably operable at variable rates such that an activating input from the sensor 82 will cause the rapid and almost instantaneous deployment of the panel 60, while activation based upon inputs from the switch element 84 will result in substantially reduced rates of deployment. Moreover, it is contemplated that the system will incorporate a resettable lockout feature which prohibits the motor 80 from acting upon a signal from the switch element 84 once a signal has been received from the sensor 82. In this manner, the occupant of the vehicle is prevented from inadvertently retracting the panel 60 during the occurrence of a roll-over collision event.

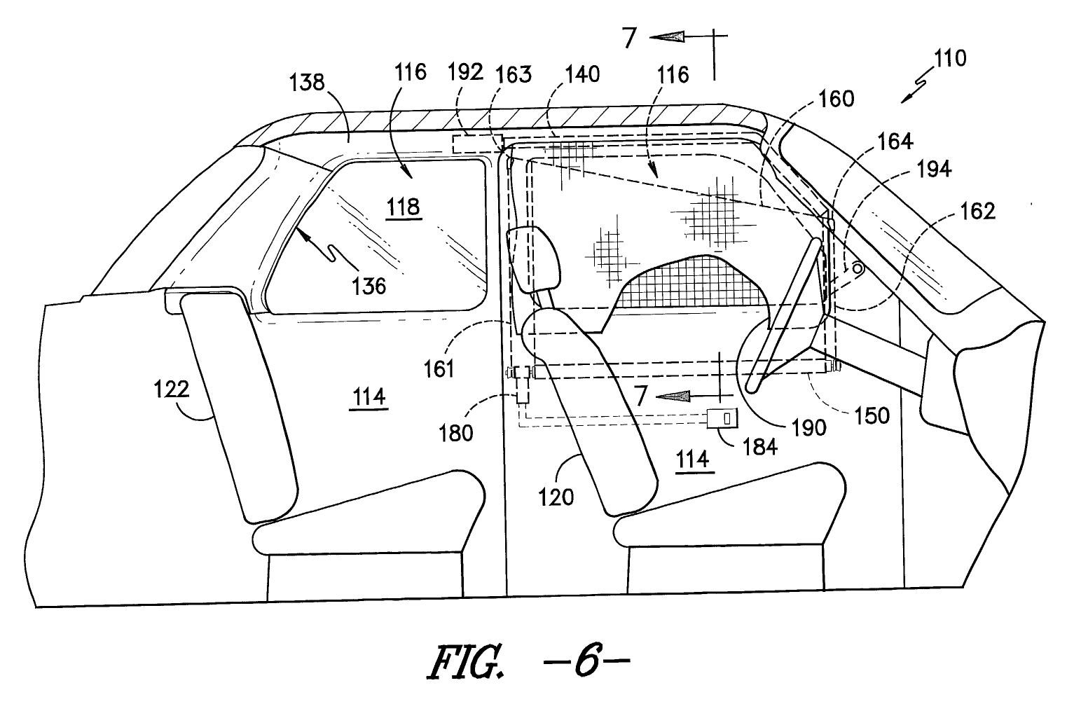

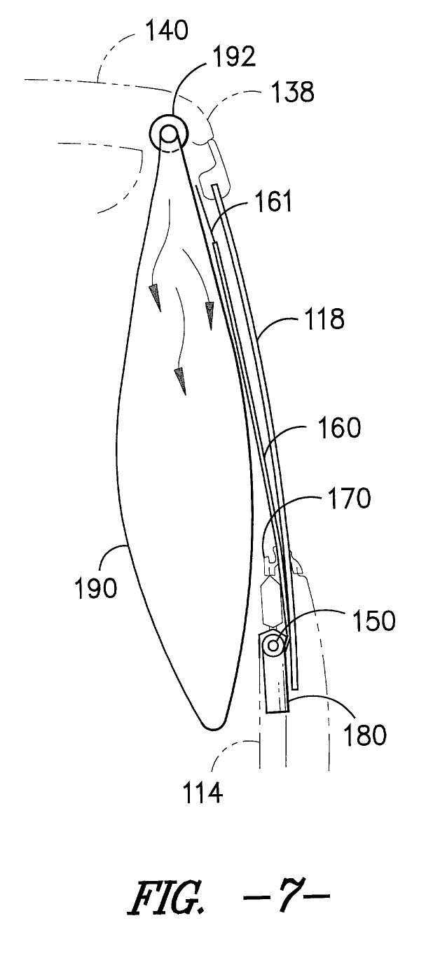

In the raised position, the panel 60 provides potentially beneficial restraint to an occupant within the vehicle 10 when operated independently in the manner as described above. Moreover, the system may also incorporate the use of one or more cooperating inflatable cushions of the type as will be well known to those of skill in the art. A system according the present invention which utilizes such an inflatable air bag cushion is illustrated in FIGS. 5-7 in which components similar to those previously described in relation to FIGS. 1-4 are denoted by like reference numerals increased by 100.

According to the illustrated exemplary embodiment of a system according to the present invention which utilizes an inflatable air bag cushion, the panel 160 is preferably raised away from its storage position generally below the window opening 116 by retraction of hoist lines 161, 162 in the manner previously described. Additional cushioning restraint is further provided by a deployable inflatable cushion 190 stored generally above the window opening 116. The inflatable cushion 190 may be attached along its upper edge to the roof rail 138 and at least partially down the forward structural pillar 132 in the manner shown. The inflatable cushion 190 is in fluid communication with a gas generating inflator 192 which discharges an inflating gas upon the receipt of a signal from a sensor upon the occurrence of predetermined vehicle conditions. In this regard, it is contemplated that a common sensor may be used both to activate the inflator 192 as well as the reversible motor 180 although separate sensors may likewise be utilized if desired. Upon activation of the inflator 192, inflation gas is caused to enter the inflatable cushion 190 thereby forcing the inflatable cushion 190 away from its storage position and downwardly over the window opening 116. A degree of tensioning may be maintained across the lower edge of the inflatable cushion 190 by a rotatable tether 194 attached near the base of the forward pillar 132.

Simultaneous with the deployment of the inflatable cushion 190, the panel 160 is raised away from its storage position such that the panel 160 is positioned generally outboard of the inflatable cushion 190 thereby assuming an orientation between the inflatable cushion 190 and the retractable window 1 18 substantially as illustrated in FIG. 7. In such a cooperating system, the inflatable cushion 190 serves to provide additional cushioning to a vehicle occupant while the raised panel 160 provides a tensioned backing support for the cushion. Such an arrangement of elements may be maintained throughout an extended roll-over collision event providing a cushioning barrier against undesired egress through the window opening 116 even if the window 118 may be broken away.

As will be appreciated, the use of the upwardly deployable panel 160 and generally downwardly deployable inflatable cushion 190 has been illustrated relative to a single window opening 116 for exemplary purposes only. Such structures may, of course, be applied across any number of window openings within the vehicle 110 where cushioning restraint may be desired.

It is to be understood that while the present invention has been illustrated and described in relation to certain potentially preferred embodiments, constructions, and procedures, that such embodiments, constructions, and procedures are illustrative only and that the present invention is in no event to be limited thereto. Rather, it is contemplated that modifications and variations embodying the principles of this invention will no doubt occur to those of skill in the art to which the invention pertains. It is thus contemplated and intended that the present invention shall extend to all such modifications and variations as may incorporate the broad aspects of the invention within the full spirit and scope thereof.

1. A safety system for protection of an occupant within a transportation vehicle, the safety system comprising: a panel of pliable material normally stored in a nonactivated storage position generally below a window opening adjacent to the occupant, the panel of pliable material being deployable upwardly away from the storage position at least partially across the window opening such that the panel of pliable material forms a restraining barrier at least partially across the window opening.

2. The invention as recited in claim 1, wherein the pliable material is a net structure comprising a plurality of crossing structural elements separated by interstitial voids.

3. The invention as recited in claim 1, wherein the panel is retractable to the storage position generally below the window opening subsequent to deployment.

4. The invention as recited in claim 1, wherein the panel is manually activatable upon demand by an occupant within the vehicle.

5. The invention as recited in claim 1, wherein the panel is substantially see through.

6. The invention as recited in claim 5, wherein the panel comprises a light interrupting grating such that the panel provides a see through shade against sunlight.

7. The invention as recited in claim 1, wherein the panel is deployable in a plane of deployment inboard of a window disposed at least partially across the window opening.

8. The invention as recited in claim 7, wherein the panel is deployable upwardly between the window and a sealing strip inboard of the window along the lower boundary of the window opening.

9. The invention as recited in claim 1, wherein the panel of pliable material is operatively connected to an arrangement of hoist lines extending away from the panel and wherein the operative length of the hoist lines is adjustable such that upon shortening the operative length of the hoist lines, the panel is raised away from its nonactivated storage position.

10. A safety system for protection of an occupant within a transportation vehicle, the safety system comprising: a panel of pliable material normally stored in a nonactivated storage position generally below a window opening adjacent to the occupant, the panel of pliable material being deployable upwardly away from the storage position at least partially across the window opening, the safety system further comprising an inflatable air bag cushion deployable between the occupant and the panel of pliable material such that the panel of pliable material provides a backing support for the inflatable air bag cushion.

11. The invention as recited in claim 10, wherein the inflatable air bag cushion is deployable downwardly away from a storage position above the window opening.

12. The invention as recited in claim 10, wherein the pliable material is a net structure comprising a plurality of crossing structural elements separated by interstitial voids.

13. The invention as recited in claim 10, wherein the panel is retractable to the storage position generally below the window opening subsequent to deployment.

14. The invention as recited in claim 10, wherein the panel is manually activatable upon demand by an occupant within the vehicle prior to deployment of the inflatable air bag cushion.

15. The invention as recited in claim 14, wherein the panel is substantially see through.

16. The invention as recited in claim 15, wherein the panel comprises a light interrupting grating such that the panel provides a see through shade against sunlight prior to deployment of the inflatable air bag cushion.

17. The invention as recited in claim 10, wherein the panel is deployable upwardly between a moveable window within the window opening and a sealing strip inboard of the window, wherein the sealing strip extends along the lower boundary of the window opening.

18. The invention as recited in claim 10, wherein the panel of pliable material is operatively connected to an arrangement of hoist lines extending away from the panel and wherein the operative length of the hoist lines is adjustable such that upon shortening the operative length of the hoist lines, the panel is raised away from its nonactivated storage position.

19. A safety system for protection of an occupant within a transportation vehicle, the safety system comprising: a panel of pliable material normally stored in a nonactivated storage position generally below a window opening adjacent to the occupant, the panel of pliable material being deployable upwardly away from the storage position at least partially across the window opening by a plurality of hoist lines extending away from the panel and over pulley guides disposed adjacent to lateral edges of the window opening, the hoist lines being operatively connected to length adjusting take up mechanisms disposed below the pulley guides to lengthen or shorten the operative length of the hoist lines such that upon shortening the operative length of the hoist lines the panel is raised into an operational position at least partially spanning the window opening.

20. The invention as recited in claim 19, wherein the length adjusting take up mechanisms comprise reversible take up rolls driven by a reversible motor.

21. The invention as recited in claim 20, further comprising a reversible storage roll supporting the panel at the storage position generally below the window opening, the reversible storage roll being operatively connected to the reversible take up rolls along a common spindle such that the reversible motor causes the substantially simultaneous rotation of the reversible storage roll and the reversible take up rolls.

22. The invention as recited in claim 19, further comprising an inflatable air bag cushion deployable between the occupant and the panel of pliable material such that the panel of pliable material provides a backing support for the inflatable air bag cushion.

23. The invention as recited in claim 22, wherein the inflatable air bag cushion is deployable downwardly away from a storage position above the window opening.
